(19) United States
(12) Patent Application Publication
(10) Pub. No.: US 2008/0213636 A1
(43) Pub. Date: Sep. 4, 2008

(54) Reformer, Fuel Cell System and Method For Operating a Fuel Cell System

(75) Inventor: Matthias Boltze, Neuendorf (DE)

Correspondence Address: ROBERTS MLOTKOWSKI SAFRAN & COLE, P.C., P. O. BOX 10064, MCLEAN, VA, 22102-8064, US

(73) Assignee: Enerday Gmbh, Stockdorf (DE)

(21) Appl. No.: 11/908,201

(22) PCT Filed: Mar. 6, 2006
(86) PCT No.: PCT/DE06/00383

§ 371 Date: Sep. 10, 2007

(30) Foreign Application Priority Data
Mar. 9, 2005 (DE) 10 2005 010 935.7

(51) Int. Cl. H01M 8/06; C01B 3/00

(52) U.S. Cl. 429/17; 423/248; 429/19

(57) ABSTRACT

A fuel cell system (10) having a reformer (12) having a burner (14) and a catalyst (16) and provided for reacting fuel and oxidant into a reformate, and having a fuel cell (24), particularly a high-temperature fuel cell which, on the basis of reformate generated by the reformer, generates electric energy and thereby liberates anode exhaust gas (26). The system is provided with a blower (28) and injector (30) oxidant feed arrangement with which, all of the anode exhaust gas is delivered to the burner. A method for operating the fuel cell system for reacting fuel (18) and oxidant (20) into a reformate (22) involves aspirating the anode exhaust gas into the oxidant feed arrangement, feeding it to the burner together with fuel and with the burner exhaust being delivered with additional fuel to the catalyst to produce reformate that is delivered to the fuel cell.

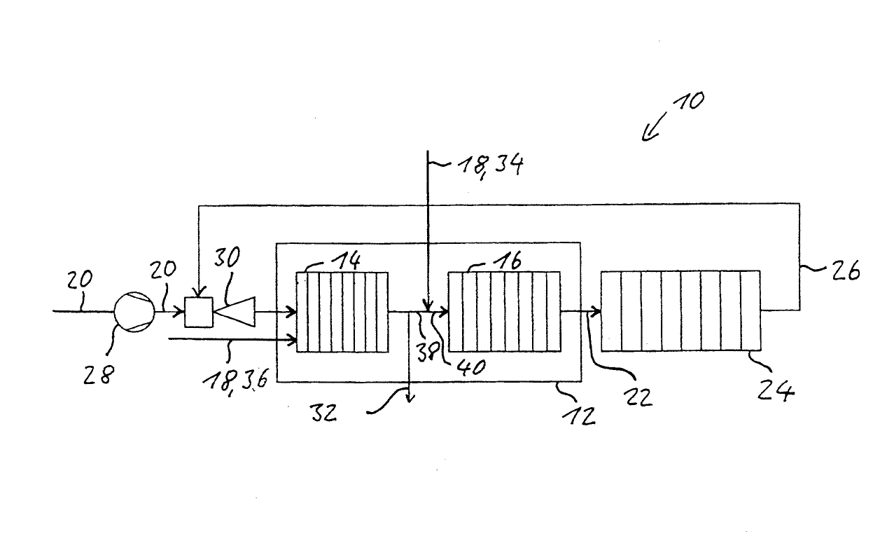

### BACKGROUND OF THE INVENTION

1. Field of the Invention

The invention relates to a fuel cell system featuring a reformer having a burner and a catalyst and provided for reacting fuel and oxidant into a reformate, including a fuel cell, particularly a high-temperature fuel cell which, on the basis of reformate generated by the reformer, generates electricity and thereby liberating anode exhaust gas.

The invention also relates to a reformer for reacting oxidant and fuel into a reformate suitable for operating a fuel cell, particularly a high-temperature fuel cell, the reformer having a burner and, downstream thereof, a catalyst.

The invention also relates to a method for operating a fuel cell system, particularly a high-temperature fuel cell system comprising the steps:
reacting fuel and oxidant into a reformate in a reformer having a burner and a catalyst,
generating electricity in a fuel cell, particularly a high-temperature fuel cell on the basis of reformate and thereby liberating anode exhaust gas.

In addition, the invention relates to a method of reacting fuel and oxidant into a reformate which is suitable for operating a fuel cell, particularly a high-temperature fuel cell.

2. Description of Related Art

Fuel cell systems, particularly fuel cell systems engineered for operating with liquid fuels, such as gasoline or Diesel, require a reforming unit which reacts a mixture of an oxidant, as a rule air, and fuel vapor into a hydrogen rich reformate with which the fuel cell can be operated. Fuel cell systems, particularly high-temperature fuel cell systems, such as SOFC fuel cell systems are often engineered so that part of the anode exhaust gas is returned to the fuel gas conditioner upstream of the reformer or other components. The non-returned portion of the anode exhaust gas is combusted in its entirety in an afterburner so that the exhaust gas emerging from the afterburner can be given off to the environment.

Accordingly, achievements of this kind require two burners, namely a burner assigned to the reformer and an afterburner. This results in the known systems becoming highly complicated and costly.

### SUMMARY OF THE INVENTION

A primary object of the present invention is to reduce the complexity of generic systems and generic methods.

This object is achieved by the features of the invention described herein.

The fuel cell system in accordance with the invention is a sophistication over generic prior art in that means are provided which are suitable to return all of the anode exhaust gas to the burner. This achievement now combines the advantages of returning the anode exhaust gas with those of a reformer burner. In particular, this now eliminates the afterburner as needed in prior art, thus reducing system complexity and costs.

In preferred embodiments of the fuel cell system in accordance with the invention, just a single exhaust gas discharge is provided for discharging exhaust gas to the environment, this exhaust gas discharge being disposed between the burner and the catalyst, the burner preferably performing at least substantially total combustion.

For the fuel cell system in accordance with the invention, it is also preferred that a first fuel feed id disposed between the exhaust gas discharge and the catalyst. This kind of fuel feed into the exhaust gas leaving the burner which is not discharged to the environment is necessary to feed the catalyst as an exhaust gas/fuel mixture suitable for forming the reformate due to the fact that the burner performs a substantially total combustion.

The fuel cell system in accordance with the invention is further characterized in that it has a second fuel feed assigned to the burner. In this arrangement, the fuel can be fed to the burner both together with the anode exhaust gas and oxidant respectively as well as separately. In both cases, there is no need to permanently feed the burner with fuel since, in normal operation, the mixture of anode exhaust gas and oxidant (as a rule air) is sufficient for operating the burner at least temporarily. However, especially in the starting phase, it is of advantage or even necessary to fuel the burner directly via the second fuel feed.

Furthermore, for the fuel cell system in accordance with the invention, it is preferred that the oxidant is supplied to the burner in the form of a stream of oxidant and that the anode exhaust gas is fed to the stream of oxidant. In this achievement, it is preferred that the burner receives a separate supply of fuel.

In this case, it is preferred that the means for supplying fuel includes an injector for feeding the anode exhaust gas to the stream of oxidant. The injector may be configured for example as a kind of venturi nozzle at which a vacuum materializes which supports gas circulation and draws off exhaust gases from the output of the fuel cell.

For the fuel cell system in accordance with the invention it is also preferred that air is used as the oxidant and that the means for generating the stream of oxidant comprise a blower. In preferred embodiments, the blower is located upstream of the injector, i.e., such that the injector is disposed between the blower and the burner.

The reformer in accordance with the invention is a sophistication over generic prior art in that the burner is engineered to perform a substantially total combustion, fuel being supplied to the exhaust gas emerging from the burner to generate an exhaust gas/fuel mixture which is supplied to the catalyst. In this achievement too, the afterburner as needed in prior art is eliminated to thus result in a simplified system configuration. The embodiments as discussed in the context of the fuel cell system in accordance with the invention can be translated to the reformer in accordance with the invention, and thus, such aspects of the reformer in accordance with the invention are likewise understood to be disclosed, this applying especially to the way in which the exhaust gas is discharged between the burner and the catalyst as well as to the way in which the fuel is supplied.

The method in accordance with the invention for operating a fuel cell system is a sophistication over generic prior art in that all of the anode exhaust gas is supplied to the burner, resulting in the properties and advantages as already discussed as regards the fuel cell system in accordance with the invention to the same or similar extent so that reference is made to the fuel cell system in accordance with the invention to avoid tedious repetition.

The same applies to the preferred embodiments of the method in accordance with the invention for operating a fuel cell system as given in the following, again to which reference is made to the comments in conjunction with fuel cell system in accordance with the invention to avoid tedious repetition.

For the method in accordance with the invention, it is preferred that only a single exhaust gas discharge is made to the environment, the exhaust gas being discharged between the burner and the catalyst.

In this arrangement it is deemed an advantage that fuel is supplied between the exhaust gas discharge and the catalyst.

Furthermore, it is provided for in the method in accordance with the invention that the burner is supplied with fuel at least temporarily, preferably at least in the starting phase.

For the method in accordance with the invention for operating a fuel cell system it is also deemed an advantage that the anode exhaust gas is supplied to a stream of oxidant. In this arrangement, it is preferably provided that the anode exhaust gas is supplied to the stream of oxidant via an injector.

In this case, as explained above, it is furthermore deemed an advantage that air is used as the oxidant and that to generate the oxidant a blower is used.

The method in accordance with the invention for reacting fuel and oxidant into a reformate is a sophistication over prior art in that it comprises the following steps:
performing a substantially total combustion in a burner,
feeding fuel to exhaust gas emerging from the burner to generate an exhaust gas/fuel mixture, and
feeding the exhaust gas/fuel mixture to a catalyst to provide a reformate.

In this case too, the afterburner as needed in the prior art can be eliminated to thus reduce the costs of performing the method.

The method in accordance with the invention for reacting fuel and oxidant into a reformate can be sophisticated to advantage by the steps as explained in conjunction with the fuel cell system in accordance with the invention and method of operating a fuel cell system in accordance with the invention respectively and also such variants of the method are deemed as being disclosed. This applies also in this case, especially as regards the way in which the exhaust gas is discharged between the burner and the catalyst and the way in which the fuel is supplied to the burner.

The gist of the invention involves supplying all of the anode exhaust gas to the reformer burner and to perform in this reformer burner an at least substantially total combustion. In this case, the exhaust gas to be discharged from the system can be discharged directly and downstream of the reformer burner so that no separate afterburner is needed. Furthermore, the mixture of anode exhaust gas and oxidant (as a rule air) is in many cases suitable, at least in normal operation, to operate the burner without feeding it fuel directly.

Preferred embodiments of the invention are described in detail below with reference to the accompanying drawings.

### BRIEF DESCRIPTION OF THE DRAWING

The sole FIGURE is a block diagram of an embodiment of the fuel cell system in accordance with the invention comprising a reformer in accordance with the invention and which is suitable for performing the method in accordance with the invention.

### DETAILED DESCRIPTION OF THE INVENTION

The fuel cell system 10 as shown in the FIGURE is a solid oxide fuel cell (SOFC) high-temperature fuel cell system. The system features a reformer 12 comprising a burner 14 and a catalyst 16. The reformer 12 is provided to generate reformate 22 with which a fuel cell 24 can be operated. In accordance with the invention, means 28, 30 are provided which make it possible to feed the entirety of the anode exhaust gas 26 emerging from the fuel cell 24 to the burner 14. These means comprise, in the case shown, a blower 28 and an injector 30, which can work to advantage in accordance with the venturi principle. The blower 28 furnishes air 20 via the injector 30 as the oxidant needed to operate the burner 14 in the reformer 12, as a result of which a vacuum materializes at the injector 30 which, in turn, promotes the gas circulation and draws in anode exhaust gas 26 from the output of the fuel cell 24.

In addition to the oxidant 20 and the anode exhaust gas 26, the burner 14 also receives a supply of fuel, via a second fuel feed 36, which is combusted in its entirety in the burner 14. The exhaust gas discharge 38 from the burner 14 is supplied to the catalyst 16 together with fuel from a first fuel feed 34, so that an exhaust gas/fuel mixture is fed to the catalyst 16 suitable for generating the reformate 22 that is supplied to the fuel cell 24. The non-aspirated portion of the burner exhaust gas leaves the system as exhaust gas via an exhaust gas discharge 32.

In the catalyst 16, the exhaust gas/fuel mixture is reacted into hydrogen rich reformate 22 which is reacted in the fuel cell 24 mostly into electricity. The remnant anode exhaust gas 26 is returned via the injector 33 to the reforming process. The water contained in the anode exhaust gas 26 has a positive effect on the reforming process in that it helps avoid the system from becoming sooted up to a major extent. Furthermore, system efficiency is enhanced by the achievement in accordance with the invention.

Since the afterburner necessary with prior art solutions can be omitted in accordance with the invention, for a complete fuel cell system 10, only the reformer 12 and the fuel cell 24 are required as main components, whereby the complexity and thereby the system costs can be reduced significantly.

The invention—without being restricted thereto—is especially suitable for mobile applications, for example, in conjunction with automotive auxiliary power units (APUs).

It is understood that the features of the invention as disclosed in the present description, drawings as well as in the claims, may be essential to achieving the invention both singly and in any combination.

1-16. (canceled)

17. A fuel cell system, comprising:
a reformer having a burner and a catalyst for reacting fuel and oxidant into a reformate,
a fuel cell which receives the reformate from the reformer, generates electric energy and releases anode exhaust gas, and
means for returning all of the anode exhaust gas from the fuel cell to the burner.

18. The fuel cell system as set forth in claim 17, in which only a single exhaust gas discharge for discharging exhaust gas to the environment is provided, said exhaust gas discharge being disposed between the burner and the catalyst.

19. The fuel cell system as set forth in claim 18, wherein a first fuel feed disposed between the exhaust gas discharge and the catalyst.

20. The fuel cell system as set forth in claim 19, wherein a second fuel feed is provided which supplies fuel to the burner.

21. The fuel cell system as set forth claim 17, further comprising means to the burner in the form of a stream of oxidant and means for delivering the anode exhaust gas into the stream of oxidant.

22. The fuel cell system as set forth in claim 21, wherein the means for supplying oxidant comprises an injector which draws the anode exhaust gas into the stream of oxidant and for supplying the anode exhaust gas to the burner together with the oxidant.

23. The fuel cell system as set forth in claim 22, wherein air is supplied as the oxidant and the means for supplying comprises a blower.

24. A method for operating a fuel cell system, comprising the steps of:
reacting fuel and oxidant into a reformate in a reformer comprising a burner and a catalyst,
generating electric energy in a fuel cell from the reformate produced by the reformed and releasing anode exhaust gas,
delivering all of the anode exhaust gas to the burner.

25. The method as set forth in claim 24, wherein the exhaust gas is discharged to the environment via only a single exhaust gas discharge which is located between the burner and the catalyst.

26. The method as set forth in claim 25, wherein fuel is supplied between the exhaust gas discharge and the catalyst, is mixed with a portion of the exhaust gas from the burner that is not released to the environment via the exhaust gas discharge and delivered to the catalyst.

27. The method as set forth in claim 24, wherein the burner is supplied with fuel, at least temporarily, at least in the starting phase.

28. The method as set forth in claim 24, wherein the anode exhaust gas is delivered into a stream of oxidant delivered to the burner.

29. The method as set forth in claim 28, wherein the anode exhaust gas is drawn into the stream of oxidant via an injector.

30. The method as set forth in claim 29, wherein air is used as the oxidant and is delivered to the injector by a blower.

31. A method of reacting fuel and oxidant into a reformate which is suitable for operating a fuel cell comprising the following steps:
performing a substantially complete combustion in a burner,
feeding fuel to exhaust gas emerging from the burner to produce an exhaust gas/fuel mixture, and
feeding the exhaust gas/fuel mixture to a catalyst to produce reformate.
